(19) United States
(12) Patent Application Publication
(10) Pub. No.: US 2007/0264076 A1
(43) Pub. Date: Nov. 15, 2007

(54) Load release pin for concrete shoring apparatus

(76) Inventor: Robert McCracken, Urbandale, IA (US)

Correspondence Address: Davis, Brown, Koehn, Shors & Roberts, P.C.;The Financial Center, Suite 2500, 666 Walnut Street, Des Moines, IA, 50309-3993, US

(21) Appl. No.: 11/433,699

(22) Filed: May 12, 2006

(51) Int. Cl. F16B 21/09

(52) U.S. Cl. 403/315

(57) ABSTRACT

A load release pin for concrete forming apparatus is disclosed. The pin supports the concrete forming apparatus and any plastic concrete during forming of a concrete structure. After the concrete has set sufficiently, the pin is displaced to release the load on the forming apparatus. The pin has an asymmetric shape that prevents it from being used in an incorrect orientation. In addition, the pin provides sufficient strength to safely support the forming apparatus and any plastic concrete even if it is mistakenly inserted in the displaced position.

### BACKGROUND OF THE INVENTION

The invention relates generally to concrete form apparatus and, more specifically, to a pin that is used to support concrete shoring apparatus in a loaded, working position and which may be readily displaced to relieve the load on the shoring apparatus so that the shoring apparatus may be disassembled, moved, or the like.

Concrete forming apparatus is in wide use in the construction of buildings, bridges, and other concrete structures. A common system for forming concrete structures uses a plurality of modular form components that are adapted to be assembled into a wide variety of configurations to conform to virtually any architectural requirement. Such forming apparatus components are typically made of metal so that they are strong enough to support the heavy weight of poured concrete and durable so that the components can be reused many times.

A common application of concrete forming apparatus is in the formation of horizontal slabs, such as floors of a concrete building. Typically, pluralities of modular form panels are assembled to form the horizontal surface on which the concrete will be poured. These panels are supported on metal shore posts that typically are adjustable in length by telescopic movement between an inner and outer tube. Once the concrete has cured sufficiently to be self-supporting, the panels must be stripped away from the concrete for re-use, requiring removal of the shore posts. Because of the weight of the concrete poured on the form panels, the shore posts are under a high load. This load must be released in order to remove the shore posts. Workers have difficulty relieving the load on the shore posts. In many systems on the market, a threaded coupling is used to adjust the length of the shore post and turning the threaded coupling under high load is difficult.

Alternative existing systems make use of a shaped pin that holds the shore post in a working position at an extended length supporting one or more form panels. The load rests on a portion or portions of the pin of an increased thickness. The pin may be moved by a worker to a position which presents a reduced thickness, thus allowing the shore post tubes to telescopically collapse to a reduced length, thus relieving the load on the shore post. An example of such a system is that sold by Form Tech Concrete Forms, Inc.

A disadvantage of the existing pin systems is that the pin is made from cylindrical stock with notches milled in it to create the reduced thickness sections. The pin thus has a round transverse profile and so may be installed upside down. Another problem is that if the pin is mistakenly left in the load relieved, reduced thickness position when the shore post is used to support plastic concrete, the pin may not provide the specified strength or safety factor and could fail.

### SUMMARY OF THE INVENTION

The preferred embodiment of the present invention consists of a load release pin that supports a pair of telescoping tubes of a shore post in a loaded, working position supporting concrete forming apparatus during the forming of concrete structures. Upon sufficient curing or setting of the concrete, the pin is easily moved or displaced to allow the tubes to telescopically collapse and so relieve the load on the shore post to allow it to be disassembled or moved.

The pin has an asymmetrical profile and fits inside corresponding asymmetric openings formed in the tubes. Accordingly, the pin cannot be inserted in the openings in an upside down orientation. Sections of the pin are of an increased thickness and are intended to support the shore post in its extended length under high load. Adjacent sections of the pin are of a reduced thickness and, upon movement or displacement of the pin, allow the telescopic collapse of the tubes to relieve the load on the shore post. The reduced thickness sections are engineered to provide the specified strength and safety factor for supporting the full load so that no risk of failure exists even if the pin is used in the non-working, load-relieving position when the shore post is under full load.

An object of the present invention is to provide a load release pin for concrete forming apparatus that cannot be installed upside down.

Another object of the present invention is to provide a load release pin for concrete forming apparatus that provides the required strength and safety allowance even when positioned in the non-working, load-relieved position.

These and other objects will be understood by those skilled in the art upon a review of this specification, the associated figures and the appended claims.

### BRIEF DESCRIPTION OF THE DRAWINGS

FIG. 1 is a perspective view of a load release pin representing a preferred embodiment of the present invention.

FIG. 2 is an elevational view of a shore post in which the load release pin is used.

FIG. 3 is perspective view of a concrete forming apparatus in which a plurality of shore posts are supporting a network of primary and secondary beam members and showing a form panel attached to secondary beam members.

FIG. 4 is an enlarged, sectional view of the upper end of a shore post shown in a raised, load-supporting position in contact engagement with a form panel with the load release pin in its load-supporting position.

FIG. 5 is an enlarged, sectional view of the upper end of a shore post shown in a lowered, load-releasing position removed from contact engagement with the form panel and showing the load release pin in its load-releasing position.

### DETAILED DESCRIPTION OF PREFERRED EMBODIMENTS

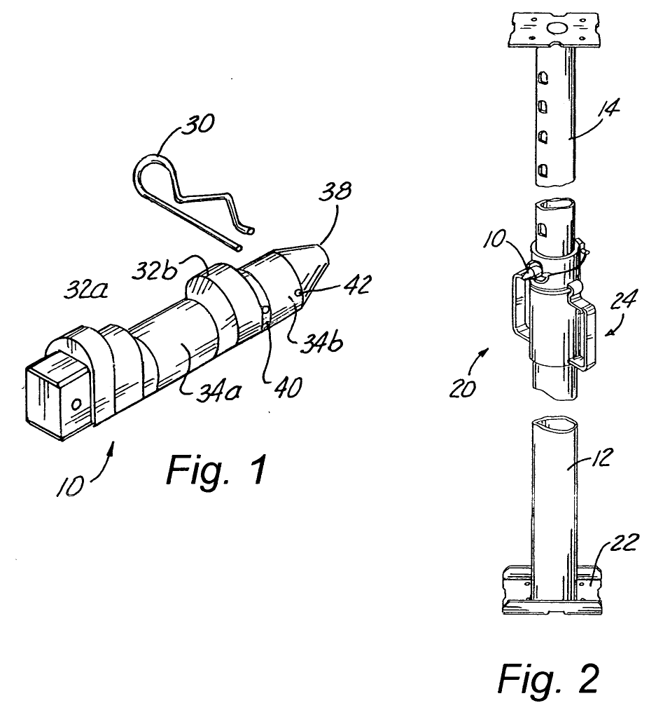

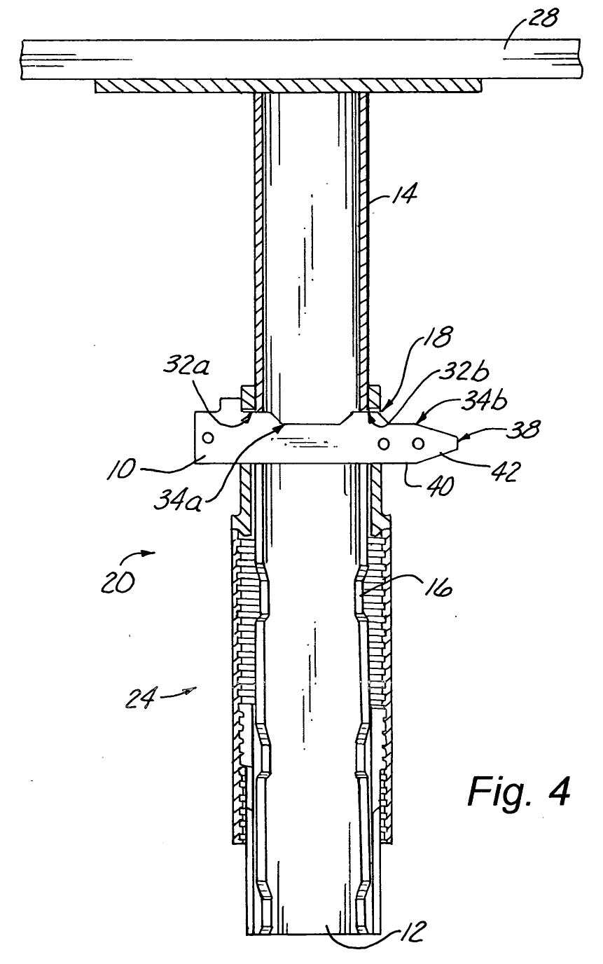

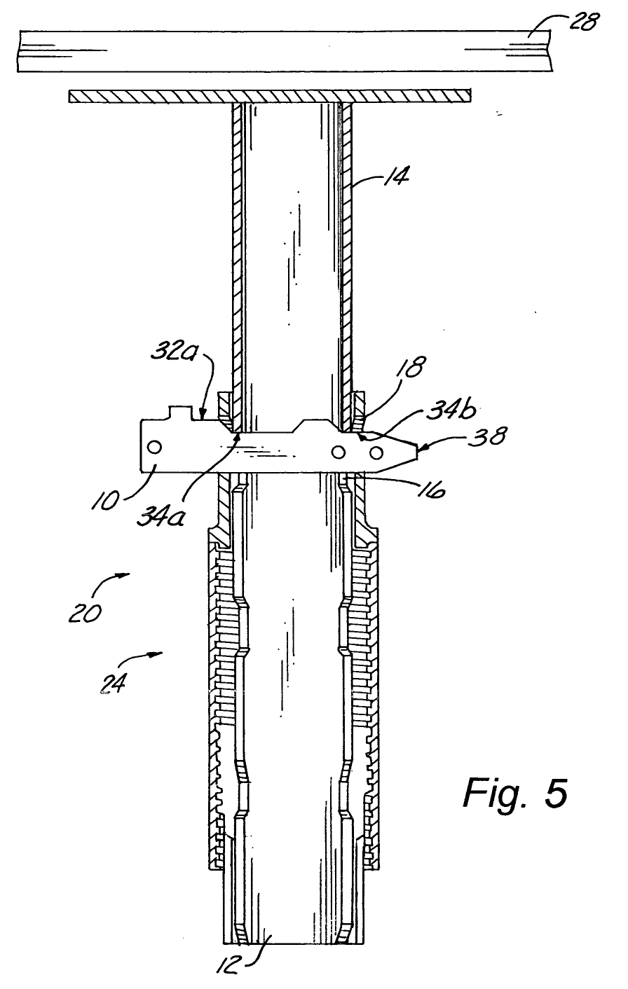

Illustrated in FIG. 1, generally at 10, is a load release pin representing a preferred embodiment of the present invention. The pin 10 is inserted into a pair of telescoping tubes, outer tube 12 and inner tube 14 (FIGS. 4 and 5). The body member of the pin 10 has a profile in transverse cross-section that is asymmetric. In a preferred embodiment, its transverse profile of the body member has a “tombstone” shape, that is an arcuate top profile, straight sides, and a flat bottom. Each of the outer tube 12 and inner tube 14 is provided with a pair of diametrically opposed openings 16 and 18, respectively, that are of a corresponding asymmetric profile as that of the pin 10, that is, an arcuate top profile, straight sides and a flat bottom, but slightly enlarged to permit passage of the pin 10. The asymmetric profile of the pin 10 and the corresponding openings 16 and 18 make it impossible for the pin 10 to be inserted into the tubes 12 and 14 in anything other than the desired orientation. In the preferred embodiment, the outer tube 12 has a plurality of diametrically opposed openings 16a, 16b, 16c, etc., and the inner tube 14 has a plurality of diametrically opposed openings 18a, 18b, 18c, etc., spaced at regular along their length.

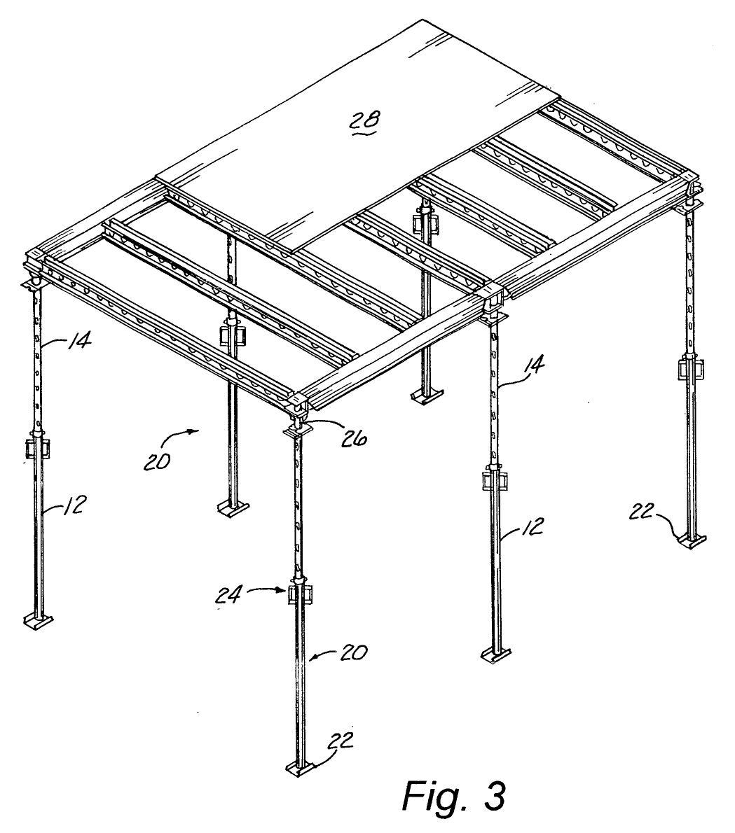

The pin 10 and tubes 12 and 14 are components of a shore post, illustrated generally at 20 in FIGS. 2 and 3. The shore post 20 also includes a foot pad 22 which supports the outer tube 12, a threaded linkage member 24 that can be rotated to adjust the length or height of the shore post 20, and a drop head 26 at the top of the inner tube 14 which assists in supporting concrete form components, such as the form panel 28 on which plastic concrete is poured and formed. In use, the shore post 20 is adjusted to approximately the correct height by telescopic movement between the outer tube 12 and the inner tube 14. Once the approximate height has been achieved, the openings 16 and 18 that most closely correspond to, but not greater than, that height are brought into alignment and the pin 10 is inserted into the aligned openings. Preferably, a retainer, such as linch pin 30, is inserted into the end of the pin 10 to prevent its accidental displacement during adjustment and placement of the shore post 20. The shore post 20 is positioned beneath a concrete forming apparatus or components thereof, such as form panel 28 and its height is adjusted up to the desired height by appropriate rotation of the threaded linkage member 24 to support the form panel 28 during pouring and setting of plastic concrete on the form panel 28 (FIG. 4).

The pin 10 has a profile that includes a first pair of spaced-apart support surfaces 32a and 32b that are in a section of the body member of the pin 10 of an increased height or thickness and a second pair of spaced-apart support surfaces 34a and 34b that are in a section of the body member of the pin 10 of a reduced height or thickness. Sloped ramp surfaces 36a and 36b transition between the surfaces 32a and 34a, and 32b and 34b, respectively. The surfaces 32a, 32b and 34a, 34b are spaced apart by a distance corresponding to the diameter of the inner tube 14, as illustrated in FIGS. 4 and 5. Accordingly, when the pin 10 is inserted into the telescoping tubes 12 and 14, it may be positioned in either a working or loaded position wherein the inner tube 14 rests on the raised support surfaces 32a, 32b (FIG. 4) or a load-relieved position wherein the inner tube 14 rests on the reduced height support surfaces 34a, 34b (FIG. 5). Movement of the pin 10 in a withdrawing direction, for example by striking the pointed end 38, from the loaded position (FIG. 4) to the relieved position (FIG. 5) will permit the inner tube 14 to fall inside the outer tube 12 from its raised position (FIG. 4) to its lowered position (FIG. 5).

Upon sufficient curing of the concrete atop the form panels 28 (FIG. 2), stripping of the form panel 28 requires that the shore post 20 be reduced in height so that the form panel 28 can be lowered from the formed concrete surface. This is accomplished by displacing the load release pin 10 from the loaded position (FIGS. 2 and 4) to its relieved position (FIGS. 3 and 5) whereupon the inner tube 14 shifts downwardly inside the outer tube 12 by the height difference between the support surfaces 32 and 34. This quickly and easily relieves the load on the support post 20 allowing further reduction in height, if needed or desired, by rotation of the threaded linkage member 24.

In the preferred embodiment, two openings 40 and 42 are provided in the pin 10 for placement of the linch pin 30 (FIG. 1). The opening 40 is exposed outside of the outer tube 12 only when the pin 10 is fully inserted in the telescoping tubes 12 and 14 and thereby supporting the inner tube 14 in the working or loaded position. Insertion of the linch pin 30 in the opening 40 will thus assure that the pin 10 does not shift to the relieved position during adjustment and use of the shore post 20 to support the form panel 28 and any plastic concrete that may be present. To relieve the load on the shore post 20, a worker would first remove the linch pin 30 to permit movement of the pin 10 to the relieved position. The opening 42 is exposed outside of the outer tube 12 when the pin 10 is in the relieved position whereupon the linch pin 30 may be inserted in the opening 42 to prevent the pin 10 from falling out of the openings 16 and 18.

Note that while it is intended that the pin 10 be in the loaded position (FIG. 4) when supporting the form panel 28 and any plastic concrete, the pin 10 is engineered so that even the thickness of the pin 10 at the reduced support surfaces 34 is sufficient to meet the required strength standard and any safety margin. Accordingly, even if a worker mistakenly uses a shore post 20 to support form panels 28 and plastic concrete with the inner tube 14 supported on the surfaces 34a, 34b, the pin 10 does not provide a risk of failure.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

I claim:

1. A load release pin inserted at a desired orientation in openings of a concrete forming apparatus, on which plastic concrete is placed and allowed to at least partially cure, for supporting the concrete forming apparatus at a raised, loaded position and at a lowered, relieved position, comprising:
(a) a body member having an asymmetric transverse profile;
(b) a first section of the body member of a first thickness to support the concrete forming apparatus at the loaded position; and
(c) a second section of the body member of a second thickness that is less than the first thickness to support the concrete forming apparatus at the relieved position.

2. A load release pin as defined in claim 1, wherein the asymmetric profile of the body member prevents insertion of the pin in the openings in other than the desired orientation.

3. A load release pin as defined in claim 1, wherein the strength of the body member at the second section is at least sufficient to support the concrete forming apparatus and plastic concrete.

4. A load release pin as defined in claim 1, wherein the asymmetric transverse profile includes a flat bottom section and an arcuate top section.
